(19) United States
(12) Patent Application Publication
(10) Pub. No.: US 2013/0015691 A1
(43) Pub. Date: Jan. 17, 2013

(54) MAGNETIC BUCKLE RETENTION SYSTEM

(71) Applicants: Alan C. Y. FENG, Mountain View, CA (US); Albert H. Leung, Fremont, CA (US); Colter P. Leys, Salt Lake City, UT (US)

(72) Inventors: Alan C. Y. FENG, Mountain View, CA (US); Albert H. Leung, Fremont, CA (US); Colter P. Leys, Salt Lake City, UT (US)

(73) Assignee: Orbit Baby, Inc., Newark, CA (US)

(21) Appl. No.: 13/184,379

(22) Filed: Jul. 15, 2011

(51) Int. Cl. B60N 2/26; A47D 15/00

(52) U.S. Cl. 297/256.15; 297/250.1

(57) ABSTRACT

A magnetic buckle retention system is provided including magnetic material placed along the side and/or bottom portions of a child seat. The magnetic material is adapted to attract a component of the child seat's belt harness, such as a tongue, a buckle and/or a belt. When the child seat's belt harness is in an unfastened configuration, a tongue, buckle, and/or belt portion of the belt harness may be held in place by the magnetic material at the positions described above, thus reducing the likelihood of the belt harness components interfering with the ingress and/or egress of a child seat occupant.

### BACKGROUND

1. Field

The present invention relates generally to the field of child seats, and more particularly, to child seats that are equipped with belt harnesses and are adapted for use in vehicles, strollers, rockers, and the like.

2. Description of Related Art

A conventional child seat may utilize a belt harness for securing an occupant to the seat. The belt harness may include a combination of shoulder, waist, and/or crotch belts equipped with tongues and buckles as necessary for the belt harness to fasten and unfasten an occupant to the child seat. In the unfastened configuration, the belts and/or the buckles of the child seat belt harness may rest arbitrarily on the seat's seating surface, and may thus interfere with an occupant's ingress into and/or egress away from the child seat. For example, during ingress, a child may sit on a belt or a buckle that is resting on the seating surface, thereby trapping the belt and/or buckle between the child and the seating surface. A trapped belt and/or buckle may be inaccessible for fastening, and may also cause the child discomfort. Similarly, during egress, an unfastened belt and/or buckle may latch onto the limbs of a seated child, thereby making the child's egress cumbersome.

### BRIEF SUMMARY

In one embodiment, a child seat is disclosed. The child seat may comprise a seat, a shoulder belt connected to the seat, and/or a crotch buckle connected to the seat. The shoulder belt may include a tongue portion, and the crotch buckle may fasten with the tongue portion of the shoulder belt. On the side of the seat is a location that may couple magnetically with the shoulder belt. The shoulder belt may be held against the side of the seat and away from the seating surface of the seat when the tongue portion of the shoulder belt is coupled magnetically with the location on the side of the seat.

In some embodiments, the side of the seat may couple magnetically with the tongue portion of the shoulder belt. In other embodiments, the side of the seat may couple magnetically with the belt portion of the shoulder belt.

In one embodiment, a child seat is disclosed. The child seat may comprise a seat and a crotch buckle connected to the seat. The seat may also include magnetic material attached to a bottom of the seat, and the magnetic material may couple magnetically with the crotch buckle. In some embodiments, when the bottom of the seat is coupled magnetically with the crotch buckle, a face of the crotch buckle lies on the bottom of the seat, and an opening of the crotch buckle is in a forward-facing direction.

In one embodiment, a child seat is disclosed. The child seat may comprise a seat, a shoulder belt, a waist belt, and a crotch buckle that may be all connected to the seat. On the side of the seat may be a location that may couple magnetically with the shoulder belt and/or the waist belt. On the bottom of the seat may also be a location that may couple magnetically with the crotch buckle. In some embodiments, when the bottom of the seat is coupled magnetically with the crotch buckle, a face of the crotch buckle lies on the bottom of the seat, and an opening of the crotch buckle is in a forward-facing direction.

In some embodiments, the tongue portion and/or the crotch buckle comprises a ferrous metal. In some embodiments, the tongue portion and/or the crotch buckle comprises a magnetic material. In some embodiments, the location on the side of the seat and/or the location on the bottom of the seat comprises a ferrous metal. In some embodiments, the location on the side of the seat and/or the location on the bottom of the seat comprises a magnetic material.

### DESCRIPTION OF THE FIGURES

FIG. 1 is a front view of an embodiment of a child seat employing the present technology in an exemplary configuration.

FIG. 2 is a front view of an embodiment of a child seat employing the present technology in an exemplary configuration.

FIG. 3 is a side view of an embodiment of a child seat employing the present technology.

FIG. 4 is a top view of an embodiment of a child seat employing the present technology.

FIG. 5 is a front view of another embodiment of a child seat employing the present technology in an exemplary configuration.

FIG. 6 is a front view of another embodiment of a child seat employing the present technology in an exemplary configuration.

FIG. 7 is a front view of another embodiment of a child seat employing the present technology in an exemplary configuration.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

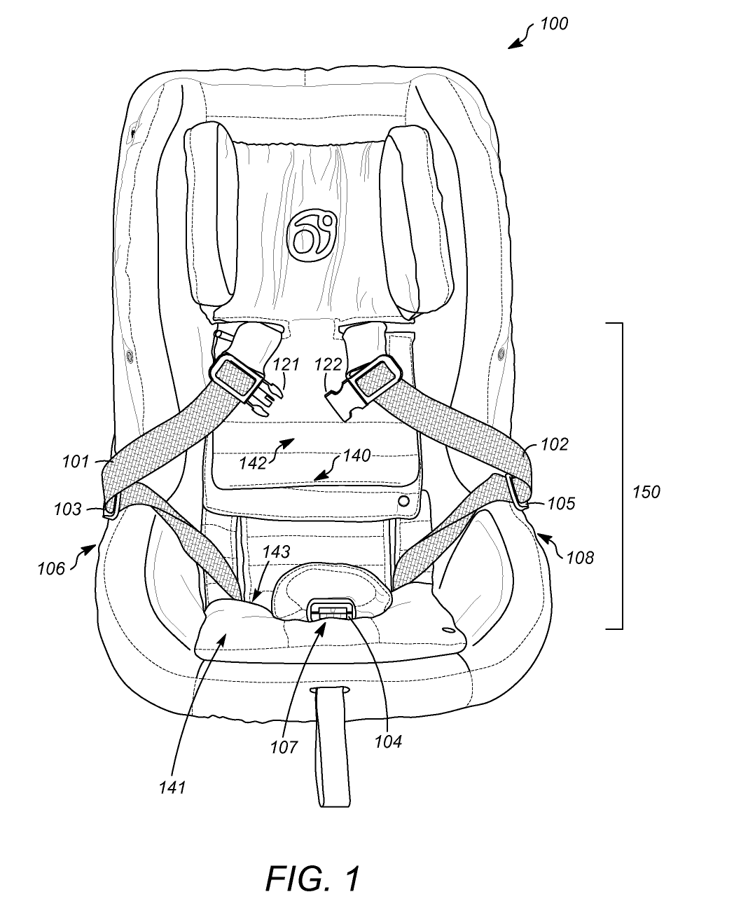

FIG. 1 depicts an embodiment of child seat 100 employing the present technology in an exemplary configuration. In this example, child seat 100 may use belt harness 150 for securing a child into the child seat. Belt harness 150 may include shoulder belts 101 and 102, tongues 103 and 105 connected to shoulder belts 101 and 102, respectively, and crotch buckle 104. As shown, belt harness 150 may be in an unfastened configuration, meaning that shoulder belts 101 and 102 may be separated from crotch buckle 104. During normal operation, a child may be placed into child seat 100 while child seat 100 is in the unfastened configuration. The child may be secured to child seat 100 by inserting tongues 103 and 105 into crotch buckle 104 in such a way that belt harness 150 may become fastened. Further, the placement of shoulder belts 101 and 102 against the child occupant may be adjusted using optional fastening clip assemblies 121 and 122.

The present technology may improve the usability of child seat 100 in the unfastened configuration. Specifically, in the unfastened configuration, tongues 103 and 105 may be held in positions 106 and 108, respectively, such that tongues 103 and 105 are directed away from seating surface 140 of child seat 100. In some embodiments, tongues 103 and 105 may be held at positions 106 and 108 by magnetic material attached to the side of child seat 100 near positions 106 and 108. Tongues 103 and 105 may be made using a ferrous metal so that they may be attracted to the magnetic field produced by the magnetic material. As used here, magnetic material may include magnets and/or other ferromagnetic material. Further, crotch buckle 104 may also be maintained in a forward-facing direction at position 107 by magnetic material placed near position 107. As used here, the forward-facing direction may be the direction in which an occupant of child seat 100 faces. The assembly of crotch buckle 104 may include a ferrous metal so that crotch buckle 104 may be attracted to the magnetic field of the magnetic material near position 107.

It should be noted that the placement of magnetic material and ferrous metals may vary. For example, in some embodiments, ferrous metals may be attached to the side of child seat 100 near positions 106 and 108, and tongues 103 and 105 may include magnetic materials.

The placement of tongues 103 and 105 away from seating surface 140 while belt harness 150 is in an unfastened configuration eases an occupant's ingress into and/or egress from child seat 100 because shoulder belts 101 and 102 may be directed away from the occupant's path to child seat 100. Further, tongues 103 and 105 may also be less likely to become trapped between a seated occupant and seating surface 140 if tongues 103 and 105 are maintained at positions 106 and 108. It may be difficult to retrieve tongues 103 and 105 for fastening with crotch buckle 104 if tongues 103 and 105 are trapped underneath a seated occupant. Similarly, the placement of crotch buckle 104 on bottom seating surface 141 in a forward-facing fashion near position 107 may reduce the chance of trapping crotch buckle 104 between the buttocks of an occupant and seating surface 140, and may promote the accessibility of crotch buckle 104 through the thighs of a seated occupant.

Although FIG. 1 illustrates exemplary positions 106-108 that may couple with the components of belt harness 150, a person having ordinary skill in the art would appreciate that the present technology may allow for various placements of tongues and crotch buckles, meaning that the exact locations of positions 106-108 may vary in different embodiments. Generally, it may be desirable to place belt harness components away from the seating surface (e.g., 140) of a child seat (e.g., 100). Further, the present technology may be directed at placing belt harness components away from the load-bearing portions of seating surface 140. For example, seat bottom 141 and/or upper back support 142 areas of seating surface 140 may be load-bearing in that these areas may support a significant amount of the weight of an occupant. The present technology may also be directed at placing belt harness components away from areas of seating surface 140 that may become inaccessible when child seat 100 is occupied. For example, lower back area 143 may become inaccessible when child seat 100 is occupied.

Further, a person having ordinary skill in the art would appreciate that child seat 100 may be any type of child seat that may be typically used with a harness system. For example, child seat 100 may be adapted for use in a vehicle, a stroller, a rocker, a high chair, a bassinet, and the like.

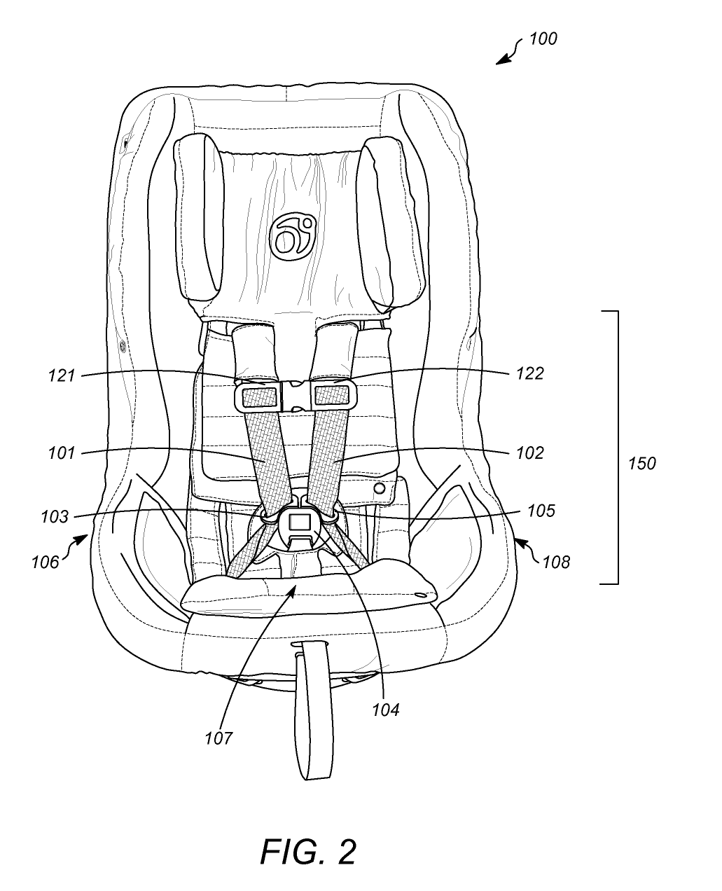

FIG. 2 depicts an embodiment of child seat 100 employing the present technology in another exemplary configuration. In this example, belt harness 150 may be in a fastened configuration, meaning that shoulder belts 101 and 102 may be secured with crotch buckle 104 by fastening tongues 103 and 105 with crotch buckle 104. Shoulder belts 101 and 102 may be furthered secured with optional clip assemblies 121 and 122. Notably, the operation of belt harness 150 remains unaffected by the presence of magnetic materials at positions 106, 107, and/or 108. In other words, the present technology may be adapted for use with a belt harness of existing design without affecting the performance of the belt harness and/or the child seat to which it may be attached.

The adaptability of the present technology into a belt harness of existing design may be desirable because a belt harness may undergo rigorous testing before it may be approved for use in a child seat. The present technology may be adaptable because the tongue of a belt harness of existing design may be produced using a ferrous metal that is attracted to a magnetic field. Similarly, a crotch buckle assembly of existing design may contain ferrous metal that causes the crotch buckle to be attracted to a magnetic field. In some embodiments, additional ferrous metal and/or magnetic material may be added to a tongue and/or a crotch buckle to increase its attraction with a magnetic field.

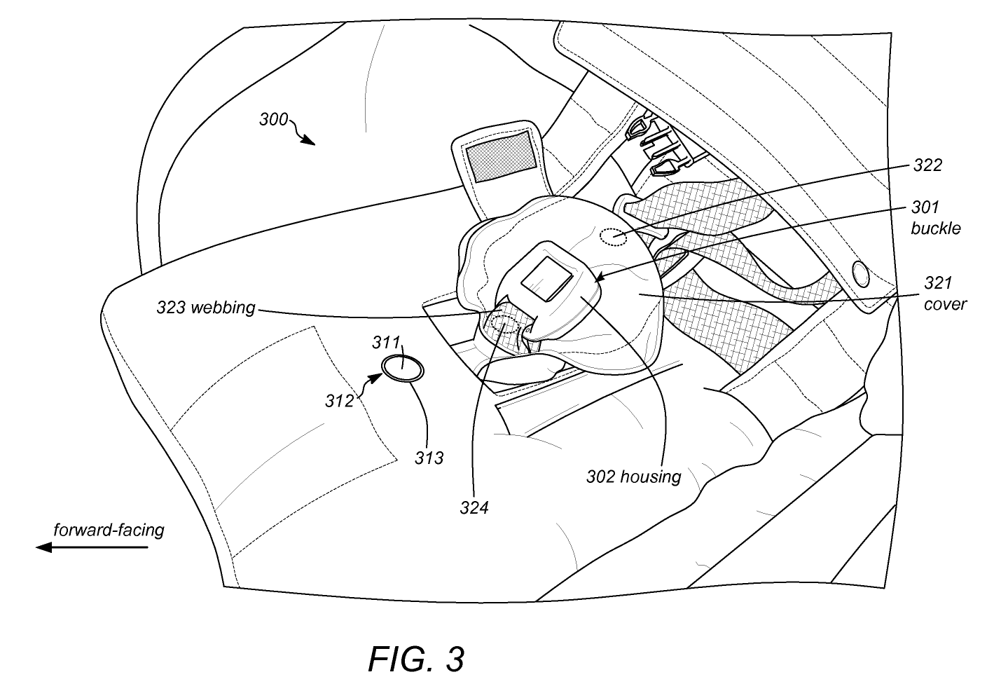

FIG. 3 illustrates seat bottom portion 300 which may represent seat bottom portion 141 (FIG. 1) of child seat 100 (FIG. 1) in one embodiment. When child seat 100 (FIG. 1) is in the unfastened configuration, crotch buckle 301 may be adapted to rest on seat bottom portion 300 in a forward-facing direction near position 311. Magnetic material 312 may be embedded (e.g., sewn) into or may be otherwise attached (e.g., glued) to the fabric of seat bottom portion 300 near position 311. Position 311 may have visible marking 313 that indicates the presence of nearby magnetic material 312, since magnetic material 312 may be attached to seat bottom portion 300 in a way that magnetic material 312 may be hidden from view. Housing 302 of crotch buckle 301 may house and/or include ferrous metal such that crotch buckle 301 may be attracted to a magnetic field. Similarly, housing 302 of crotch buckle 301 may house and/or include additional magnetic material such that crotch buckle 301 may be attracted to a magnetic field. The magnetic field may be produced by magnetic material 312 at position 311.

Optionally, ferrous metal and/or magnetic material 324 may be sewn into crotch buckle webbing 323 such that crotch buckle webbing 323 may be attracted to a magnetic field such as the magnetic field produced by magnetic material 312 at position 311. As used here, the webbing of the crotch buckle may refer to a fabric, a belt, or the like that connects the crotch buckle to child seat 100 (FIG. 1). Further, optionally, ferrous metal and/or magnetic material 322 may be sewn into crotch buckle fabric cover 321 such that crotch buckle fabric cover 321 may be attracted to a magnetic field such as the magnetic field produced by magnetic material 312 at position 311.

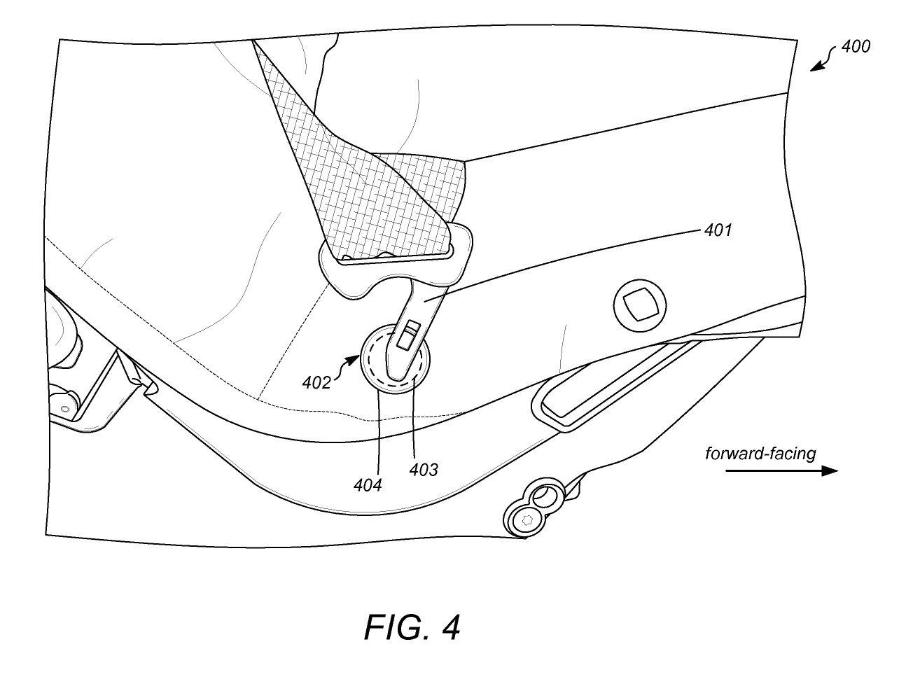

FIG. 4 illustrates seat portion 400 which may represent a side of child seat 100 (FIG. 1) in one embodiment. When child seat 100 (FIG. 1) is in an unfastened configuration, tongue 401 may be held in position 402 of seat portion 400 through magnetic attraction between tongue 401 and a magnetic material near position 402. As discussed above, the maintenance of tongue 401 at position 402 may ease the ingress of an occupant into child seat 100 (FIG. 1).

In some embodiments, magnetic material 403 may be embedded (e.g., sewn) into or may be otherwise attached (e.g., glued) to the fabric near position 402. Position 402 may have visible marking 404 that indicates the presence of nearby magnetic material 403, since magnetic material 403 may be attached near position 402 in such a way that magnetic material 403 may not be visible. Tongue 401 may be composed of a ferrous metal such that it may be attracted to a magnetic field such as the magnetic field produced by magnetic material 403.

In other embodiments, ferrous metal 403 may be embedded (e.g., sewn) into or may be otherwise attached (e.g., glued) to the fabric near position 402. Position 402 may also have visible marking 404. Tongue 401 may be composed of a magnetic material such that it may be attracted to ferrous metal 403 at position 402. In yet another embodiment, tongue 401 may include ferrous metal and/or magnetic material, and seat 400 may include ferrous metal and/or magnetic material near position 402.

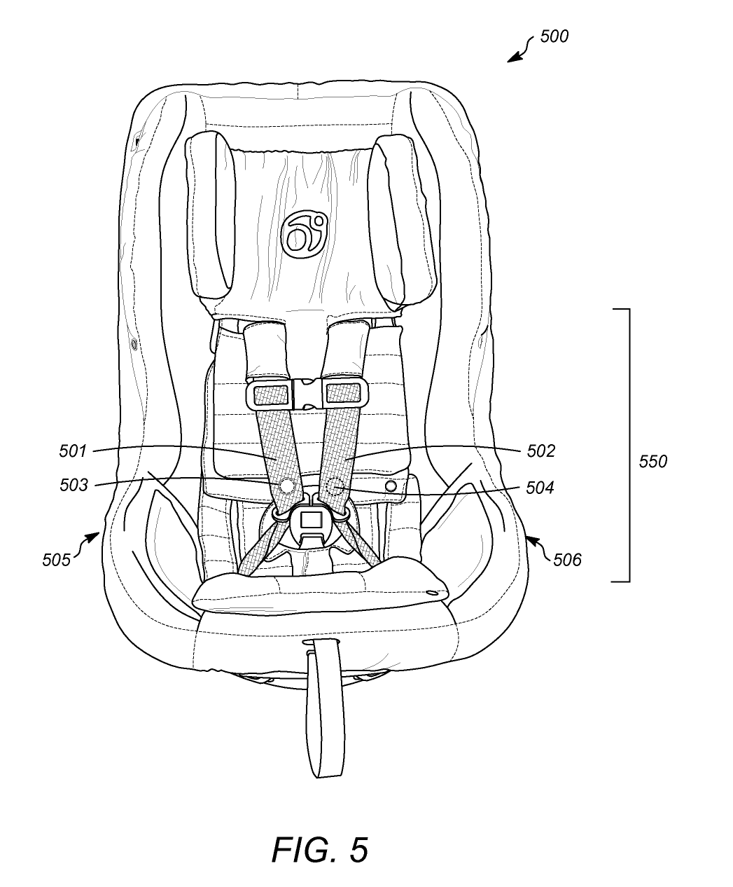

FIG. 5 depicts another embodiment of child seat 500 employing the present technology in an exemplary configuration. In this example, ferrous metal and/or magnetic material may be attached to the belt portions of shoulder belts 501 and 502 near positions 503 and 504. The attached ferrous metal and/or magnetic material may couple magnetically with sides 505 and 506 of child seat 500. The attached ferrous metal and/or magnetic material may be embedded (e.g., sewn) into or may be otherwise attached (e.g., glued) to the fabric of shoulder belts 501 and 502. The attached ferrous metal and/or magnetic material may be visible, as is the case at position 503. The attached ferrous metal and/or magnetic material may also be hidden from view, as is the case at position 504. Positions 503 and 504 may have visible markings that indicate the presence of the attached ferrous metal and/or magnetic material.

A person having ordinary skill in the art would appreciate that that the materials used at positions 503-506 may vary. For example, position 505 may contain magnetic material that is adapted to couple magnetically with a ferrous metal embedded at position 503, or vice versa. As another example, magnetic materials may be attached to both positions 505 and 503 of child seat 500.

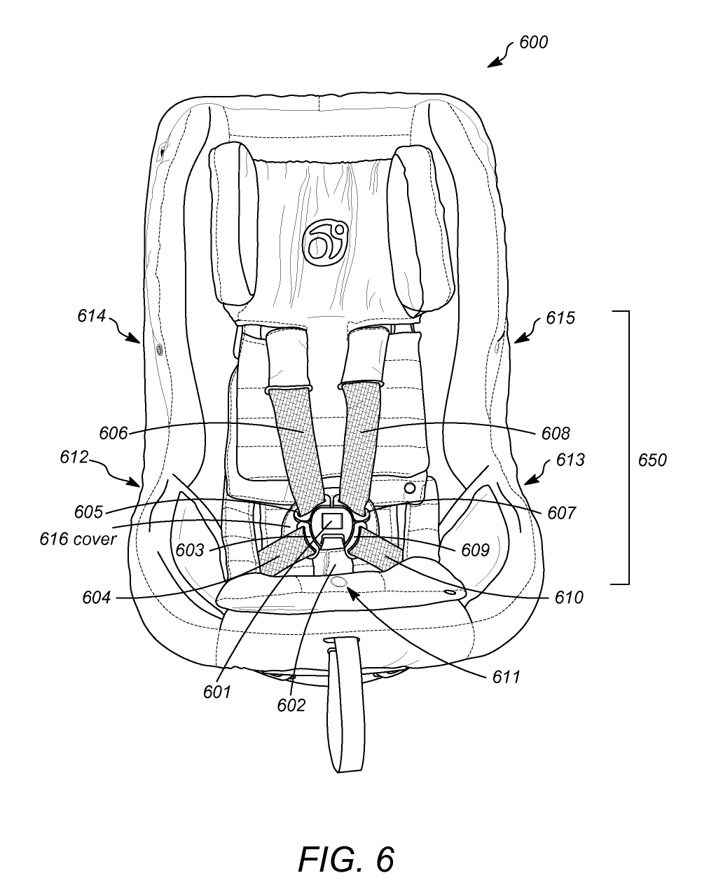

FIG. 6 depicts another embodiment of child seat 600 employing the present technology in an exemplary configuration. In this example, belt harness 650 may be a five-point harness in a fastened configuration, meaning that waist belts 604 and 610 and shoulder belts 606 and 608 may be secured with crotch buckle 601. Crotch buckle 601 may be adapted to become fastened with metal tongues 603, 605, 607, and 609 of belts 604, 606, 608, and 610, respectively. Magnetic material may be placed at positions 611, 612, 613, 614, and 615 of child seat 600. Further, crotch buckle 601, crotch buckle webbing 602, and/or crotch buckle fabric cover 616 may include ferrous metal and/or magnetic material.

A person having ordinary skill in the art would appreciate that waist belts 604 and 610, which fasten against the waist of an occupant, may be replaced with lap belts which fasten against the lap of an occupant. In addition, in other embodiments, child seat 600 may employ other belt harness designs, such as a four-point harness design.

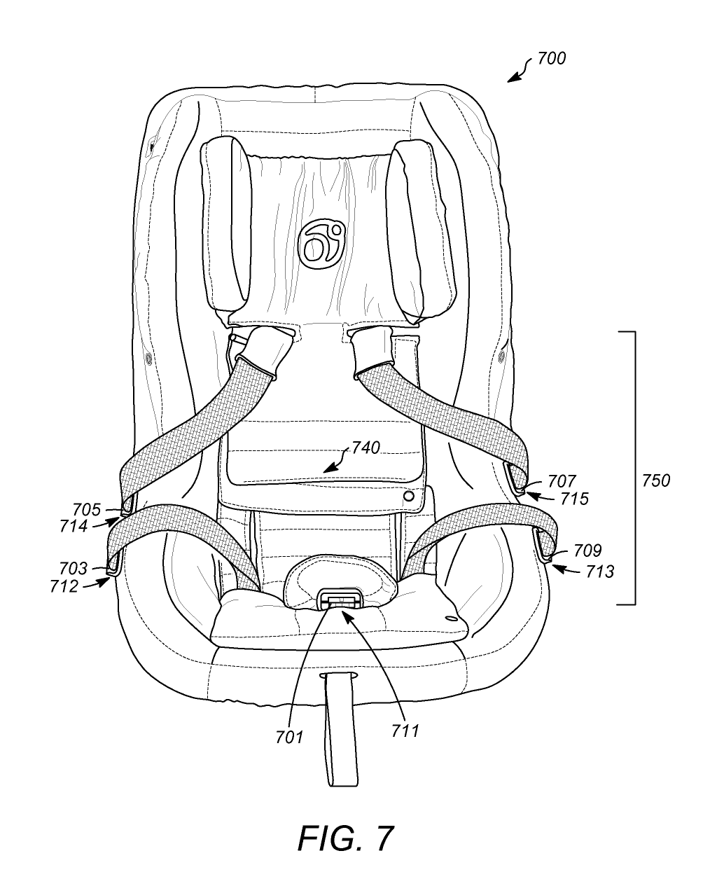

FIG. 7 depicts another embodiment of child seat 700 employing the present technology in another exemplary configuration. In this example, belt harness 750 may be in an unfastened configuration, meaning that waist metal tongues 703, 705, 707, and 709 may be separated from crotch buckle 701. In the unfastened configuration, crotch buckle 701 may rest in a forward-facing fashion on seating area 740 near magnetic material placed at position 711. Further, metal tongues 703, 705, 707, and 709 may be held in place by corresponding magnetic materials located near positions 712, 713, 714, and 715. A shown in FIG. 7, seating area 740 may be free from metal tongues that may interfere with an occupant's ingress into child seat 700.

The foregoing descriptions of specific embodiments have been presented for purposes of illustration and description. They are not intended to be exhaustive, and it should be understood that many modifications and variations are possible in light of the above teaching.

What is claimed is:

1. A child seat, comprising:
a seat;
a shoulder belt connected to the seat, wherein the shoulder belt includes a tongue portion;
a crotch buckle connected to the seat, wherein the crotch buckle is adapted to fasten with the tongue portion of the shoulder belt; and
a location on a side of the seat adapted to couple magnetically with the shoulder belt.

2. The child seat of claim 1, wherein:
the shoulder belt is held against the side of the seat and away from a seating surface of the seat when the tongue portion of the shoulder belt is coupled magnetically with the location on the side of the seat.

3. The child seat of claim 2, wherein:
the location on the side of the seat includes a magnetic material;
the tongue portion of the shoulder belt includes a ferrous metal; and
the magnetic material is adapted to couple magnetically with the ferrous metal.

4. The child seat of claim 2, where:
the location on the side of the seat includes a ferrous metal;
the tongue portion of the shoulder belt includes a magnetic material; and
the magnetic material is adapted to couple magnetically with the ferrous metal.

5. The child seat of claim 1, wherein:
the shoulder belt is held against the side of the seat and away from a seating surface of the seat when a belt portion of the shoulder belt is coupled magnetically with the location on the side of the seat.

6. The child seat of claim 5, wherein:
the location on the side of the seat includes a magnetic material;
the belt portion of the shoulder belt includes a ferrous metal; and
the magnetic material is adapted to couple magnetically with the ferrous metal.

7. The child seat of claim 5, where:
the location on the side of the seat includes a ferrous metal;
the belt portion of the shoulder belt includes a magnetic material; and
the magnetic material is adapted to couple magnetically with the ferrous metal.

8. The child seat of claim 1, further comprising:
a crotch buckle webbing connected to the seat and the crotch buckle, wherein:
the crotch buckle webbing is adapted to couple magnetically with a location on the bottom of the seat.

9. The child seat of claim 1, further comprising:
a magnetic material attached to a bottom of the seat, wherein the magnetic material is adapted to couple magnetically with the crotch buckle.

10. The child seat of claim 9, wherein:
when the magnetic material is coupled magnetically with the crotch buckle, a face of the crotch buckle lies on the bottom of the seat, and an opening of the crotch buckle is in a forward-facing direction.

11. The child seat of claim 9, further comprising:
another magnetic material attached to the crotch buckle,
wherein the other magnetic material attached to the crotch buckle is adapted to couple magnetically with the magnetic material attached to the bottom of the seat.

12. The child seat of claim 9, further comprising:
a crotch buckle cover connected to the seat; and
another magnetic material attached to the crotch buckle cover, wherein the other magnetic material attached to the crotch buckle cover is adapted to couple magnetically with the magnetic material attached to the bottom of the seat.

13. The child seat of claim 9, further comprising:
a crotch buckle cover connected to the seat; and
another magnetic material attached to the crotch buckle cover, wherein the other magnetic material attached to the crotch buckle cover is adapted to couple magnetically with crotch buckle.

14. The child seat of claim 9, further comprising:
another magnetic material in a housing of the crotch buckle, wherein the other magnetic material in the housing is adapted to couple with the magnetic material attached to the bottom of the seat.

15. The child seat of claim 9, further comprising:
a crotch buckle cover connected to the seat, and
a crotch buckle webbing connected to the seat and the crotch buckle, wherein:
both the crotch buckle cover and the crotch buckle webbing are not adapted to couple magnetically with the magnetic material attached to the bottom of the seat.

16. A child seat, comprising:
a seat;
a crotch buckle connected to the seat; and
a magnetic material attached to a bottom of the seat, wherein the magnetic material is adapted to couple magnetically with the crotch buckle.

17. The child seat of claim 16, wherein:
when the magnetic material is coupled magnetically with the crotch buckle, a face of the crotch buckle lies on the bottom of the seat, and an opening of the crotch buckle is in a forward-facing direction.

18. The child seat of claim 16, further comprising:
another magnetic material attached to the crotch buckle,
wherein the other magnetic material attached to the crotch buckle is adapted to couple magnetically with the magnetic material attached to the bottom of the seat.

19. The child seat of claim 16, further comprising:
a crotch buckle cover connected to the seat;
another magnetic material attached to the crotch buckle cover, wherein the other magnetic material attached to the crotch buckle cover is adapted to couple magnetically with the magnetic material attached to the bottom of the seat.

20. The child seat of claim 16, further comprising:
a crotch buckle cover connected to the seat; and
another magnetic material attached to the crotch buckle cover, wherein the other magnetic material attached to the crotch buckle cover is adapted to couple magnetically with crotch buckle.

21. The child seat of claim 16, further comprising:
another magnetic material in a housing of the crotch buckle, wherein the other magnetic material in the housing is adapted to couple with the magnetic material attached to the bottom of the seat.

22. A child seat, comprising:
a seat;
a shoulder belt connected to the seat, wherein the shoulder belt includes a tongue portion;
a waist belt connected to the seat, wherein the waist belt includes another tongue portion;
a location on a side of the seat adapted to couple magnetically with the shoulder belt;
another location on the side of the seat adapted to couple magnetically with the waist belt; and
the shoulder belt and the waist belt are held against the side of the seat when the belts are coupled magnetically with the locations on the side of the seat.

23. The child seat of claim 22, wherein:
the locations on the side of the seat each includes magnetic material, and
the tongue portion of the shoulder belt and the tongue portion of the waist belt each include ferrous metal.

24. The child seat of claim 22, wherein:
the locations on the side of the seat each include a ferrous metal, and
the tongue portion of the shoulder belt and the tongue portion of the waist belt each include a magnetic material.
